(19) United States
(12) Patent Application Publication
(10) Pub. No.: US 2001/0024919 A1
(43) Pub. Date: Sep. 27, 2001

(54) Headliner assembly

(76) Inventors: Normand R. Marceau, Linden, MI (US); Janusz P. Gorowicz, Pinckney, MI (US); Larry F. Kocher, Canton, MI (US); Alan D. Picken, Milford, MI (US)

Correspondence Address: CLARK HILL, P.C., 500 WOODWARD AVENUE, SUITE 3500, DETROIT, MI, 48226, US

(21) Appl. No.: 09/758,060

(22) Filed: Jan. 10, 2001

Related U.S. Application Data
(60) Provisional application No. 60/175,338, filed on Jan. 10, 2000.

(51) Int. Cl. B32B 27/04; B32B 5/02; B32B 27/12; D03D 15/00

(52) U.S. Cl. 442/361; 428/354; 428/373; 428/395; 442/149; 442/196; 442/189; 442/190; 442/408

(57) ABSTRACT

A headliner assembly comprising a core layer having upper and lower surfaces and formed of loosely intertangled polyester fibers. An upper bi-component layer of densely intertangled polyester fibers is attached to the upper surface of the core layer by a web adhesive and a lower bi-component layer of densely intertangled polyester fibers is attached to the lower surface of the core layer by a web adhesive. An outer covering layer is attached to the upper bi-component layer for providing an aesthetically pleasing outer appearance to the headliner assembly. Alternatively, the bi-component layers may be attached to the core layer by intertangling fibers of the bi-component layer with fibers of the core layer adjacent each of the upper and lower surfaces.

### BACKGROUND OF THE INVENTION

1. Field of the Invention

The subject invention relates to a vehicle headliner assembly and method of making the vehicle headliner assembly.

2. Description of the Related Art

Vehicle headliners for covering an interior of a roof of a vehicle are well known in the automotive industry. Typically, the vehicle headliner is manufactured from materials chosen based upon ease of manufacturing. Vehicle headliners are commonly manufactured from materials which will give the headliner sufficient structural integrity to maintain a molded shape. An example of a headliner composition could include a matrix of fiberglass fibers and resin mixed with either a solid or liquid urethane. The fiberglass and urethane combination provides the structural support to allow the headliner to maintain a molded shape. Other materials such as polyester are used to finish the headliner and provide an aesthetically pleasing appearance. However, the use of liquid components when manufacturing the headliners creates a complicated and costly process. Additionally, in recent years there has been significant pressure to manufacture automobile trim components from recyclable materials. Headliner assemblies made with fiberglass and liquid or dry urethane may be only 20% recyclable, or not recyclable at all.

### SUMMARY OF THE INVENTION

The present invention relates to a headliner assembly comprising at least one core layer having upper and lower surfaces and formed of loosely intertangled polyester fibers and a pair of bi-component layers formed of densely intertangled polyester fibers and attached to the respective upper and lower surfaces of the core layer. The headliner assembly further includes an outer covering layer attached to at least one of the bi-component layers for providing an aesthetically pleasing outer appearance.

The headliner assembly further includes an upper bi-component layer attached to the upper surface of the core layer by a web adhesive and a lower bi-component layer attached to the lower surface of the core layer by a web adhesive.

The present invention also relates to a method a making a headliner assembly including the steps of providing at least one core layer having upper and lower surfaces and formed of loosely intertangled polyester fibers; attaching an upper bi-component layer formed of densely intertangled polyester fibers to the upper surface of the core layer by intertangling fibers of the bi-component layer with fibers of the core layer; and attaching a lower bi-component layer formed of densely intertangled polyester fibers to the lower surface of the core layer by intertangling fibers of the bi-component layer with fibers of the core layer. Alternatively, the core layer and bi-component layers may be adhered together with a layer of web adhesive.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side view of a headliner assembly incorporating the aspects of the subject invention;

FIG. 2 is a side view of an alternative embodiment of the headliner assembly having multiple core layers;

FIG. 3 is a side view of another alternative embodiment of the headliner assembly which eliminates a web adhesive;

FIG. 4 is a side view of the headliner assembly showing a bi-component being needled to the core layer.

FIG. 5 is a side view of yet another alternative embodiment of the headliner assembly having multiple core layers and eliminating the web adhesive;

FIG. 6 is a side view of the headliner assembly of FIG. 3 incorporating an outer covering; and

FIG. 7 is a side view of the headliner assembly of either FIG. 1 or FIG. 3 in an after molded state.

### DETAILED DESCRIPTION OF THE EMBODIMENTS

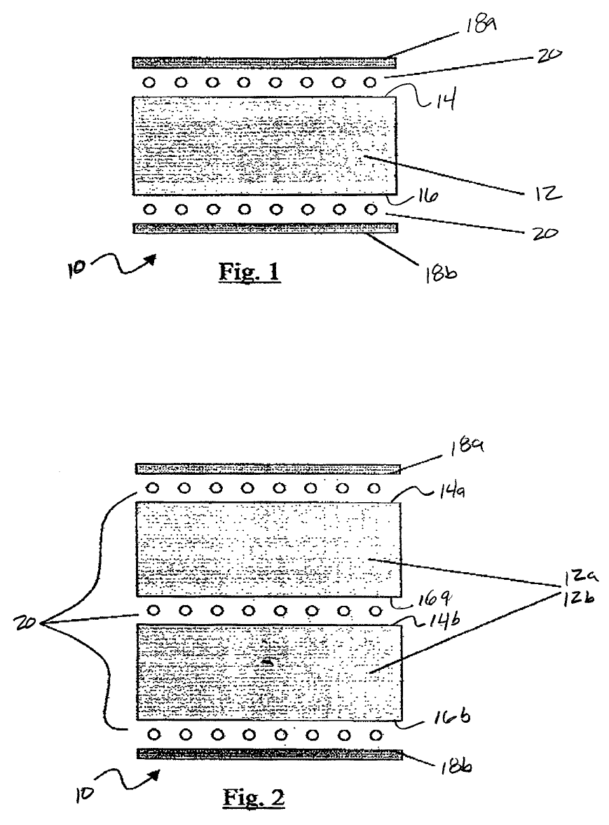

Referring to the Figures, wherein like numerals indicate like or corresponding parts throughout the several views, a headliner assembly of the present invention is generally shown at 10. Referring to FIG. 1, the headliner assembly 10 includes a core layer 12 having upper and lower surfaces 14, 16 and a bi-component layer 18a, 18b attached to each of the upper and lower surfaces 14, 16 of the core layer 12. That is, an upper bi-component layer 18a is attached to the upper surface 14 and a lower bi-component layer 18b is attached to the lower surface 16 of the core layer 12. The bi-component layers 18a, 18b are attached to the core layer 12 by a layer of web adhesive 20.

In the preferred embodiment, the bi-component layers 18a, 18b are formed of polyester fibers with a density roughly between 3 to 20 ounces per square yard. The polyester fibers of the bi-component layers 18a, 18b are needled to inter-tangle the particular fibers of polyester thereby causing the fibers to compress and become dense. Specifically, a layer of loosely inter-tangled polyester fibers are placed within a press which repeatedly cycles a plurality of needles down into the polyester fibers. The needles include a barb at a distal end which is inserted into the polyester fibers. When the needle is retracted, the barb will snag some of the fibers and pull them from one side of the layer to the other. The greater the number of times the needles are cycled, the more the fibers are pulled together, and the more inter-tangled the fibers become. The inter-tangling of the fibers holds the fibers together to form a mat or layer of polyester fibers. Ultimately, the pulling of the fibers in this manner causes the layer of polyester fibers to become more densely packed and the thickness of the layer decreases. The end result for the bi-component layer 18a, 18b is a mat of densely inter-tangled polyester fibers. As appreciated, the layers of polyester fibers can be made to varying thicknesses and densities based upon the number of needling cycles applied to the polyester fibers.

The core layer 12 is also formed of polyester fibers with a density roughly between 10 to 30 ounces per square yard. The fibers of the core layer 12 are also needled, however the core layer 12 is not needled to the same extent as the bi-component layers 18a, 18b. In other words, over the same cycle period, the bi-component layers 18a, 18b are needled at a rate of the order of 1000 cycles per second, whereas the core layer 12 is needled at a rate of the order of 100 cycles per second. Therefore, the fibers in the core layer 12 remain loosely inter-tangled and the core layer 12 remains less dense and maintains a thicker profile than the more densely inter-tangled bi-component layers 18a, 18b.

The polyester fibers in the core layer 12 can be oriented either horizontally or vertically. Horizontally oriented, or homogenous fibers, can only be used when the core layer 12 is to be attached to the bi-component layers 18a, 18b with the web adhesive 20 as shown in FIG. 1. Preferably, the adhesive 20 is a polyester adhesive which may be originally in the form of a pellet, web or powder as is known in the art.

The core layer 12 and the bi-component layer or layers 18a, 18b are also made from polyester. Since the headliner assembly 10 is manufactured completely from polyester components, the headliner assembly 10 is 100% recyclable. This is an advantage over prior art headliner assemblies which included fiberglass and dry or liquid urethanes and would only be up to 20% recyclable, if at all. Also, since no liquid resins or adhesives are used, the headliner assembly 10 of the present invention is easier and cheaper to manufacture.

Referring to FIG. 2 an alternative embodiment of the headliner assembly 10 is shown which includes multiple core layers 12a, 12b in order to make the overall thickness of the headliner assembly 10 thicker. The individual core layers 12a, 12b are attached to each other with web adhesive 20. More specifically, a lower surface 16a of the core layer 12a is attached to an upper surface 14b of the core layer 12b by the web adhesive 20. The bi-component layer 18a is attached to an upper surface 14a of the core layer 12a with the web adhesive 20. Similarly, the bi-component layer 18b is attached to a bottom surface 16b of the core layer 12b with the web adhesive 20. As appreciated, any number of core layers 12 can be utilized to achieve a desired thickness for the headliner assembly 10.

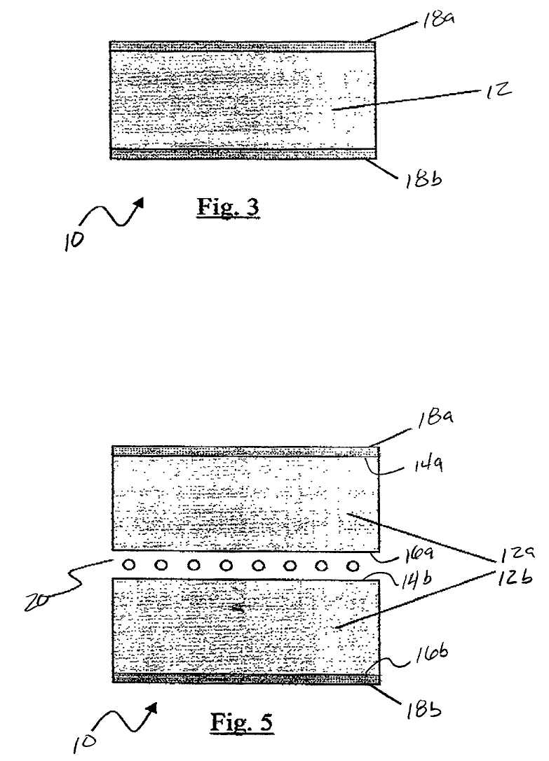

Referring to FIG. 3, another alternative embodiment of the headliner assembly 10 is shown which includes a core layer 12 and two bi-component layers 18a, 18b. In this embodiment, the bi-component layers 18a, 18b are not attached to the core layer 12 with the web adhesive 20. The bi-component layers 18a, 18b are attached to the core layer 12 by needling the bi-component layers 18a, 18b to the respective upper and lower surfaces 14, 16 of the core layer 12.

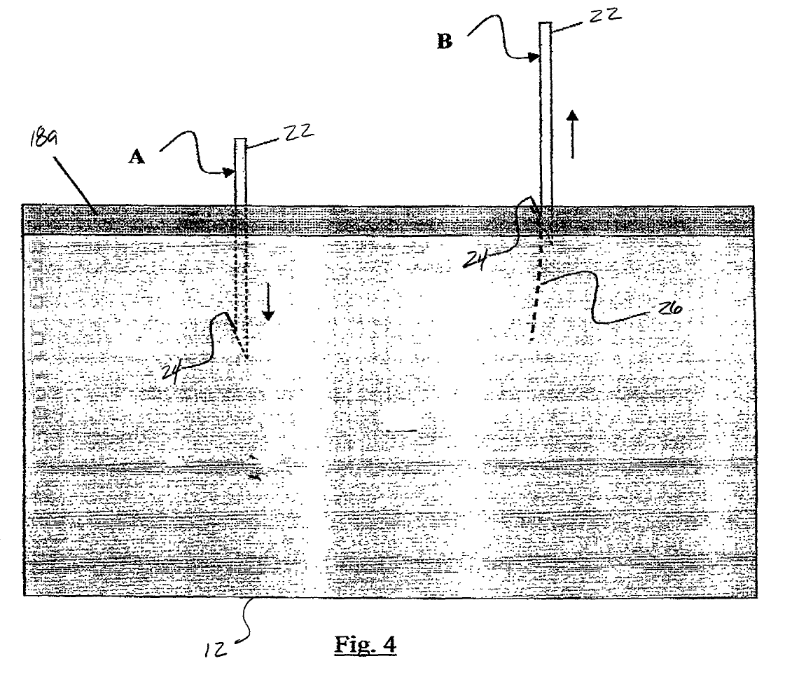

Referring to FIG. 4, the bi-component layer 18a is placed onto the core layer 12 without the web adhesive 20 between them. The core layer 12 and the bi-component layer 18a are then fed into a press to be needled. The needling as shown in FIG. 4 is similar to the needling discussed above with reference to the preferred embodiment. Specifically, needles 22 are brought down into the core layer 12 and bi-component layer 18a to a depth as shown by needle A, and then retracted from the core layer 12 and bi-component layer 18a. As the needle 22 is retracted, a barb 24 at a distal end of the needle 18 snags some of the polyester fibers 26 in the core layer 12 and pulls them up into the bi-component layer 18a as shown by needle B. After many cycles, the bi-component layer 18a is held to the core layer 12 by pulled fibers 26 that have been pulled up from the core layer 12 into the bi-component layer 18a. The core layer 12 can then be turned over, and the process is repeated on the opposite side resulting in a headliner assembly 10 having the core layer 12 with the bi-component layers 18a, 18b attached to each side without using the web adhesive 20.

The polyester fibers in the core layer 12 can be oriented either horizontally or vertically, however the fibers of the core layer 12 must be oriented vertically if the core layer 12 is to be attached to the bi-component layers 18a, 18b by needling as shown by FIG. 3 and 4. The process of needling the bi-component layers 18a, 18b to the core layer 12 is not effective when the fibers of the core layer 12 are homogenous. Additionally, when the polyester fibers of the core layer 12 are oriented vertically, the core layer 12 provides greater structural support. The combination of the vertically oriented fibers of the core layer 12 with the bi-component layers 18a, 18b attached to either side of the core layer 12 creates an I-beam like structure which will provide the headliner assembly 10 with enough structural support to maintain a molded shape. This I-beam structure allows the headliner assembly 10 to be manufactured without the need for liquid or dry urethane which are commonly used to provide structural stiffness to headliner assemblies. The absence of urethane increases the recyclability and ease of manufacture of the headliner assembly 10 as discussed previously.

Referring to FIG. 5, yet another alternative embodiment of the headliner assembly 10 is shown which includes multiple core layers 12a, 12b in order to increase the overall thickness of the headliner assembly 10. As illustrated, the bi-component layer 18a is needled to an upper surface 14a of the core layer 12a, and the bi-component layer 18b is needled to a bottom surface 16b of the core layer 12b. The lower surface 16a of the core layer 12a is attached to the upper surface 14b of the core layer 12b by using the web adhesive 20. This embodiment is essentially a combination of the embodiments shown in FIGS. 2 and 3. As appreciated, any number of core layers 12 can be utilized to achieve a desired thickness for the headliner assembly 10.

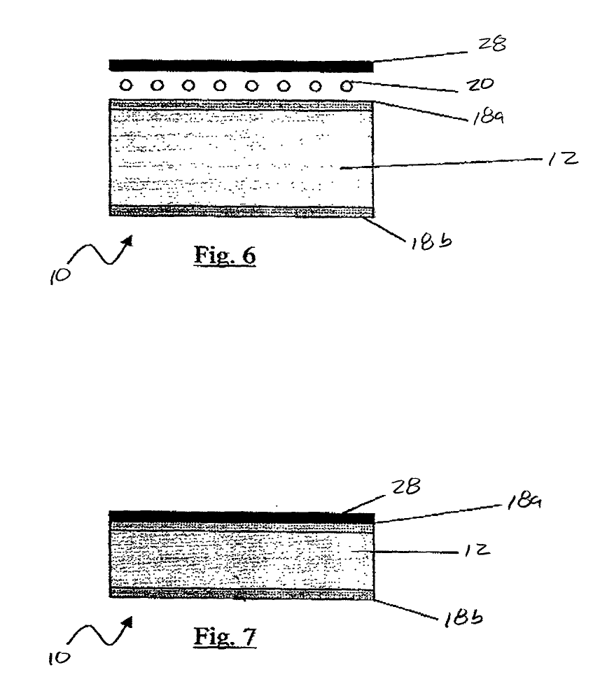

Referring to FIG. 6, the headliner assembly 10 of FIG. 3 is shown wherein the headliner assembly 10 includes an outer covering 28 attached to the bi-component layer 18a with an additional layer of the web adhesive 20. The outer covering 28 provides a cosmetically pleasing appearance for the headliner assembly 10. The outer covering 24 is applied during a molding stage of the headliner assembly 10 any may include a polyester fiber layer such as cloth.

During molding, the outer covering 28 and the layer of web adhesive 20 are placed into a mold prior to the core layer 12 and bi-component layers 18a, 18b. The core layer 12 and bi-component layers 18a, 18b are pre-heated in an oven to heat the headliner assembly 10 to a specific temperature. The pre-heated headliner assembly 10 is then placed within the mold on top of the outer covering 28, and the entire assembly is pressed to a specific shape.

The core layer 12 and the bi-component layers 18a, 18b of polyester fibers include high melt fibers and low melt fibers. The high melt fibers have a melting point which is higher than the low melt fibers. The headliner assembly 10 is pre-heated to a temperature which is above the melting point of the low melt fibers, but is lower than the melting point of the high melt fibers. Therefore, when the headliner assembly 10 is placed into the mold, the low melt fibers are somewhat melted or liquefied allowing the headliner assembly 10 to form to the mold. However, the high melt fibers remain solid, thereby keeping the fiber layers from completely breaking down to a liquid state. Referring to FIG. 6, the result is that the core layer 12 and bi-component layers 18a, 18b loose some of the original thickness associated with each layer, however each layer maintains a fibrous consistency.

The invention has been described in an illustrative manner, and it is to be understood that the terminology which has been used is intended to be in the nature of words of description rather than of limitation. Many modifications and variations of the present invention are possible in light of the above teachings. It is, therefore, to be understood that the invention may be practiced otherwise than as specifically described.

What is claimed is:

1. A headliner assembly comprising;
at least one core layer having upper and lower surfaces and formed of loosely intertangled polyester fibers; and
a pair of bi-component layers formed of densely intertangled polyester fibers and attached to said respective upper and lower surfaces of said core layer.

2. A headliner assembly as set forth in claim 1 further including an outer covering layer attached to at least one of said bi-component layers.

3. A headliner assembly as set forth in claim 2 further including an upper bi-component layer attached to the upper surface of the core layer by a web adhesive and a lower bi-component layer attached to the lower surface of the core layer by a web adhesive.

4. A headliner assembly as set forth in claim 3 further including a pair of core layers interconnected by a web adhesive between said upper and lower bi-component layers.

5. A headliner assembly as set forth in claim 4 wherein said core layers and said bi-component layers include high melt fibers and low melt fibers.

6. A headliner assembly as set forth in claim 5 wherein said assembly is 100 percent recyclable.

7. A method a making a headliner assembly including the steps of:
providing at least one core layer having upper and lower surfaces and formed of loosely intertangled polyester fibers;
adhering an upper bi-component layer formed of densely intertangled polyester fibers to the upper surface of the core layer; and
adhering a lower bi-component layer formed of densely intertangled polyester fibers to the lower surface of the core layer.

8. A method as set forth in claim 7 further including adhering an outer covering to at least one of the bi-component layers.

9. A method as set forth in claim 8 further including the step of heating the core layer and bi-component layers prior to adhering the outer covering to one of the bi-component layers.

10. A method a making a headliner assembly including the steps of:
providing at least one core layer having upper and lower surfaces and formed of loosely intertangled polyester fibers;
attaching an upper bi-component layer formed of densely intertangled polyester fibers to the upper surface of the core layer by intertangling fibers of the bi-component layer with fibers of the core layer; and
attaching a lower bi-component layer formed of densely intertangled polyester fibers to the lower surface of the core layer by intertangling fibers of the bi-component layer with fibers of the core layer.

11. A method as set forth in claim 10 further including adhering an outer covering to at least one of the bi-component layers.
